(19) United States
(12) Patent Application Publication
(10) Pub. No.: US 2009/0032194 A1
(43) Pub. Date: Feb. 5, 2009

(54) Machine for Applying Continuous-Film Labels With Pre-Applied Adhesive to Bottles

(76) Inventor: Nicola Schinelli, Porto Mantovano (IT)

Correspondence Address: Modiano & Associati, Via Meravigli, 16, Milano, 20123, IT

(21) Appl. No.: 11/887,734

(22) PCT Filed: Apr. 12, 2006
(86) PCT No.: PCT/EP2006/003382

§ 371 Date: Oct. 3, 2007

(30) Foreign Application Priority Data
Apr. 18, 2005 (IT) MN2005A000022

(51) Int. Cl. B65C 9/04

(52) U.S. Cl. 156/355

(57) ABSTRACT

A machine for applying continuous-film labels with pre-applied adhesive to bottles, comprising a cutting/transfer roller which is provided with blades which are fixed thereon, the roller being adapted to receive and retain in contact with its own surface a film in output from a feed roller in order to cut labels and move the individual labels, separated after cutting, into contact with corresponding bottles supported by a carousel.

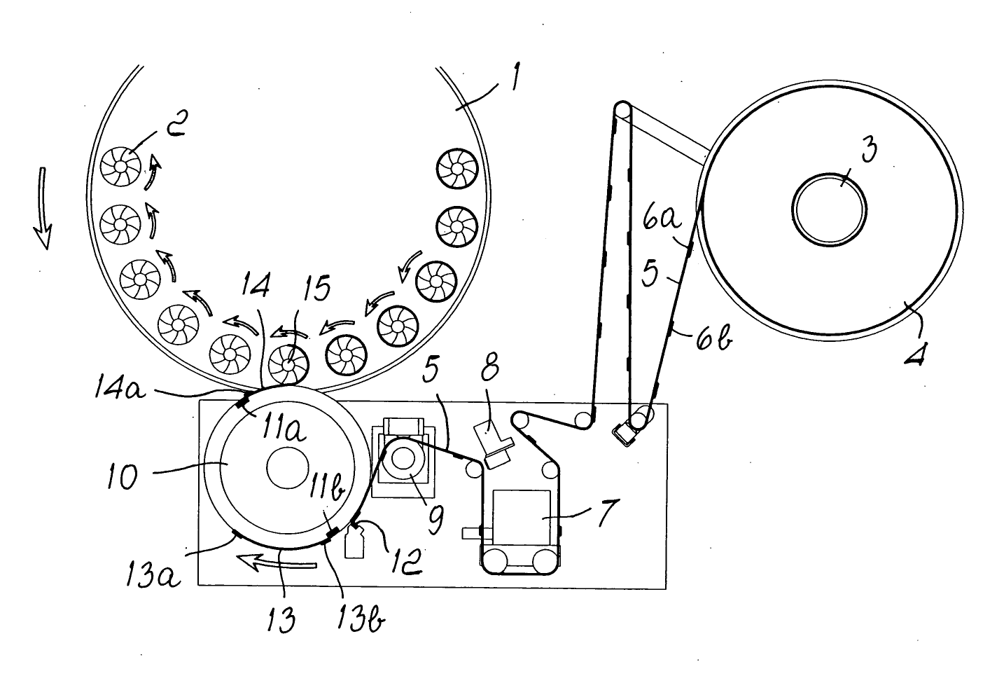

The present invention relates to a machine for applying continuous-film labels with pre-applied adhesive to bottles.

### BACKGROUND OF THE INVENTION

It is known that there are labeling machines designed to apply to bottles, this term being used to reference all kinds of container, labels which are printed on a continuous film which is wound on a reel and has portions of adhesive which are pre-applied, very commonly at the leading and trailing edges of each individual label, on the face that is designed to make contact with the bottles.

These machines comprise a rotating carousel provided with means for supporting the individual bottles adapted to turn such bottles about their own axis, and the continuous film that unwinds from the reel passes subsequently at an alignment device, at a label transit detection photocell, and at a feed roller.

In output from the feed roller, the film is engaged by a cutting roller provided with blades which, by working in combination with a fixed blade, cut the film at the notches that mutually separate the labels; in this way, the labels now separated proceed to a transfer roller in order to be conveyed so that they adhere to corresponding bottles supported by the rotating carousel.

The labels are necessarily rested on the transfer roller so that their face provided with portions of adhesive is directed outward, because in this way such portions are arranged so as to make contact with the bottles to be labeled; this leads to the fact that such labels rest on the cutting roller, which directly precedes the transfer roller, at the surface provided with the portions of adhesive.

It is well-known that the labels, due to a condition which is inherent to the operation of the machine, slide in contact with the cutting roller, and therefore the continuous sliding of the face provided with adhesive on the surface of such roller causes a loss of quality of the adhesive and a deterioration of the surface of the roller, dirtying the cutting blades and the roller, even though it is provided with a non-stick treatment, thereby causing jammings in operation.

### SUMMARY OF THE INVENTION

The aim of the present invention is to provide a labeling machine which has a distinctly simplified structure and ensures the integrity of the layer of adhesive applied to the labels and optimum operating conditions.

This aim is achieved by a machine for applying continuous-film labels with pre-applied adhesive to bottles which has the characteristics given in the appended claims.

### BRIEF DESCRIPTION OF THE DRAWING

Further characteristics and advantages of the present invention will become better apparent from the description of a preferred but not exclusive embodiment thereof, illustrated by way of non-limiting example in the accompanying drawing, wherein the only FIGURE is a schematic plan view of the machine.

### DESCRIPTION OF THE PREFERRED EMBODIMENTS

With reference to the FIGURE, the reference numeral 1 designates a carousel, which rotates in the direction of the arrow and is provided with means 2 for supporting individual bottles 15, which are turned about their own axis.

The reference numeral 3 designates a shaft for supporting a reel 4 of a film 5, which bears the labels printed continuously thereon and is provided with pre-applied portions of adhesive 6a, 6b at the leading edge and trailing edge of each label.

In unwinding from the reel 4, the film 5 passes, after a few redirections for tensioning, at an alignment device 7, at a photocell 8 for detecting the transit of labels, and at a feed roller 9.

All the rollers in contact with the adhesive-bearing side of the film 5 are provided with a non-stick treatment.

An important feature of the invention is the presence of a cutting/transfer roller 10, provided with blades 11a, 11b, which are fixed thereon and work in combination with a fixed blade 12; such roller is designed to receive the film 5 in output from the feed roller 9.

First of all, at said roller, cutting occurs of the individual labels, such as the freshly cut one designated by the reference numeral 13 with portions of adhesive 13a, 13b at its leading and trailing edges, which continue to adhere to the roller by way of the suction device with which the roller is provided. This is followed by the transfer of the labels to the corresponding bottles, as shown for label 14, which is applied to a bottle 15 in order to remain fixed to the bottle by means of the portions of adhesive provided at the leading and trailing edge, the latter being designated by the reference numeral 14a, of the label at the face directed toward the bottle 15.

The described machine has several advantageous characteristics.

First of all, attention is called to the clear simplification with respect to conventional machines, in which there are separate rollers for cutting and transferring the labels, whereas in the machine according to the invention the two functions are combined in a single roller.

Moreover, it is important to consider the fact that the labels are in contact with the cutting/transfer roller at the face that is not provided with the pre-applied portions of adhesive, and therefore the sliding of the labels in contact with the surface of the roller does not cause deterioration of the adhesive applied thereto and does not dirty the surface of the roller and the corresponding blades.

The described invention is susceptible of numerous modifications and variations, all of which are within the scope of the appended claims; thus, for example, the labels can be kept in contact with the surface of the cutting/transfer roller by way of any means.

In the practical execution of the invention, all the details may be replaced with other technically equivalent elements.

The disclosures in Italian Patent Application No. MN2005A000022 from which this application claims priority are incorporated herein by reference.

What is claimed is:

1-3. (canceled)

4. A machine for applying continuous-film labels with pre-applied adhesive to bottles, comprising a rotating carousel which is provided with means for supporting individual bottles, said supporting means being adapted to turn the bottles about their own axis, and a support for a reel of continuous film which, by unwinding, passes successively at an alignment device, at a label transit detection photocell, and at a feed roller for feeding the film, wherein a cutting/transfer roller is provided having blades which are fixed thereon, the roller being adapted to receive and retain in contact with its own surface the film in output from the feed roller in order to cut the labels and move the individual labels, separated after cutting, into contact with corresponding bottles supported by the carousel.

5. The machine of claim 4, wherein said blades of the cutting/transfer roller work in combination with a fixed blade of the machine.

6. The machine of claim 4, wherein said labels are in contact with said cutting/transfer roller at a face of said labels that is free of pre-applied portions of adhesive.
